(19) United States
(12) Patent Application Publication
(10) Pub. No.: US 2024/0411975 A1
(43) Pub. Date: Dec. 12, 2024

(54) DENSITY-AWARE FILL WITH BOUNDARY COMPENSATION

(71) Applicant: INTERNATIONAL BUSINESS MACHINES CORPORATION, ARMONK, NY (US)

(72) Inventors: DAVID WOLPERT, POUGHKEEPSIE, NY (US); MATTHEW T. GUZOWSKI, ESSEX JUNCTION, VT (US); HENRY A. BONGES, III, MILTON, VT (US); ROBERT JOHN ALLEN, JERICHO, VT (US); MARGARET ANNABELLE ALLEN, JERICHO, VT (US)

(21) Appl. No.: 18/331,914

(22) Filed: Jun. 8, 2023

(51) Int. Cl. G06F 30/392

(52) U.S. Cl. CPC G06F 30/392

(57) ABSTRACT

Density-aware fill with boundary compensation is disclosed, including identifying, based on one or more metal density constraints, a minimum density requirement for an integrated circuit (IC) design; determining a metal density for a tile of the IC design; identifying a target amount of metal fill based on metal density and the minimum density requirement; and integrating metal fill in the IC design based on the target amount of metal fill.

### BACKGROUND

### Field of the Disclosure

The field of the disclosure is integrated circuit design, or, more specifically, methods, apparatus, and products for density-aware fill with boundary compensation.

### Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

While metal is used in a semiconductor die for signal interconnects and power interconnects, metal fill may also be used to provide structural integrity to the die. This metal fill is ‘dummy metal’ in that it does not create an interconnect between devices. Metal fill gives a more even distribution of metal across the die by adding non-functional metal shapes to open regions in a design. This uniformity of metal density helps reduce thickness variations and dishing, which may occur during planarization through chemical-mechanical polishing (CMP). Fill tooling is a standard part of the IC design flow that involves adding metal shapes or polygons to the design that are structural, not logical.

The IC design is subject to a number of design rules related to metal density. Design rules are typically applied per metal layer, and a design may be subdivided into tiles for analysis. Design rule checking (DRC) is a design process to determine if chip layout satisfies a number of rules, such as density constraints, as defined by the semiconductor manufacturer. Each semiconductor process will have its own set of rules and ensure sufficient margins such that normal variability in the manufacturing process will not result in chip failure. While DRC may be employed at any phase of the design to preemptively identify design rule violations, the final IC design will undergo DRC after all phases of the IC design flow are complete. Because DRC is computationally intensive and time consuming, it is advantageous to limit the number of times it must be performed. Typically, any design rule violations are fixed manually, which is also a time-consuming endeavor.

One design rule related to metal density may specify a minimum density requirement for a given tile size, while another design rule may specify a maximum density constraint. There may be separate design rules for cell-level density and chip-level density. Design rules may specify a minimum metal density requirement for tile based on the metal density in a neighboring tile to avoid large deltas in metal density from one tile to the next. A multi-layer design rule may specify a minimum density requirement in a tile based on metal density in two or more metal layers. Further, there may be different minimum density requirements for bump areas (e.g., areas of the chip that will receive C4 bump package connections), as additional strain is placed on these areas when the chip is attached to a substrate or package. A design rule check is performed by the design tool to determine whether the various metal density design rules are satisfied.

To meet all of these patterning requirements, fill tooling can include fill algorithms that are carried out on each metal layer to add metal fill that ensures that the total metal density falls within a minimum amount and a maximum amount. Fill tooling may operate with gridded shapes of a specific size to simplify design rule check constraints. To satisfy the metal density design rules, one approach taken during fill tooling is to apply a ‘greedy’ algorithm to place metal fill shapes in virtually any track not occupied by a design shape (e.g., a signal or power interconnect). While such an approach is useful in satisfying metal density design rules, in many cases the resulting metal density far exceeds the minimum threshold needed to satisfy a metal density design rule. The capacitance created by metal fill can affect the timing and signal integrity of the functional interconnects, and thus degrades the performance of the semiconductor die. Therefore, it is advantageous to reduce the amount of metal fill that is added to the design during fill tooling.

### SUMMARY

Methods, apparatuses, and products for density-aware fill with boundary compensation according to various embodiments are disclosed. In accordance with embodiments, a design tool identifies the metal density in an IC design and optimizes or minimizes the inclusion of fill metal to target specific minimum density requirements. The reduction or minimization of unnecessary fill improves the power, performance, and area of paths containing wires that would otherwise have increased capacitance because of that fill. For example, power and performance will improve with reduced capacitance, while power and area will improve because of the reduced device drive strength needed to hit a given performance target. Embodiments provide optimizations to improve the runtime performance of the design tool for achieving this reduction.

An embodiment is directed to a method for density-aware fill with boundary compensation. The method includes identifying, based on one or more metal density constraints and guardbands, a minimum density requirement for an integrated circuit (IC) design. The method also includes determining a metal density for a tile of the IC design. The method further includes identifying a target amount of metal fill based on metal density and the minimum density requirement. The method still further includes integrating metal fill in the IC design based on the target amount of metal fill. In accordance with the embodiment, metal fill is minimized in an IC design based on an awareness of the existing metal density and the minimum density requirements. As such, capacitances caused by excess metal fill are avoided. Similar embodiments are directed to an apparatus and a computer program product for density-aware fill with boundary compensation.

A variation of the embodiment utilizes design rule checking before any fill is inserted to determine the metal density based on the design shapes alone, thereby avoiding multiple stages of fill insertion and/or removal. In this variation, determining a metal density for a tile of the IC design includes determining a design shape density based on design rule checking. Identifying a target amount of metal fill based on the metal density and the minimum density requirement includes determining a minimum number of fill shapes that will satisfy the minimum density requirement. Integrating metal fill in the IC design based on the target amount of metal fill includes inserting the minimum number of fill shapes into the IC design.

Another variation of the embodiment inserts metal fill (e.g., using a greedy algorithm) and predicts the metal density of the design shapes based on the number of fill shapes that were inserted, thereby minimizing computationally-intensive design rule checking to identify a design shape density. Fill shapes can then be depopulated based on the predicted design shape density and the minimum density requirement. In this variation metal fill is initially inserted. Determining a metal density for a tile of the IC design includes determining a fill density based on a number of fill shapes that were inserted and estimating, based on the fill density, a design shape density. Identifying a target amount of metal fill based on the metal density and the minimum density requirement includes determining, based on the estimation of the design shape density, a number of fill shapes that can be removed while satisfying the minimum density requirement. Integrating metal fill in the IC design based on the target amount of metal fill includes reducing metal fill that was inserted.

Yet another variation of the embodiment estimates the design shape density based on previous design iterations, thereby minimizing computationally-intensive design rule checking to identify a design shape density and avoiding multiple fill insertion/removal stages. In this variation, determining a metal density for a tile of the IC design includes estimating a design shape density based on a historical density. Identifying a target amount of metal fill based on the metal density and the minimum density requirement includes determining, based on the estimation of the design shape density, an estimated number of fill shapes will satisfy the minimum density requirement. Integrating metal fill in the IC design based on the target amount of metal fill includes inserting the estimated number of fill shapes into the IC design.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 a block diagram of an example computing system configured for density-aware fill with boundary compensation in accordance with embodiments of the present disclosure.

FIG. 2 is a flowchart of an example method for density-aware fill with boundary compensation according to some embodiments of the present disclosure.

FIG. 3 is a flowchart of an example method for density-aware fill with boundary compensation according to some embodiments of the present disclosure.

FIG. 4 is a flowchart of an example method for density-aware fill with boundary compensation according to some embodiments of the present disclosure.

FIG. 5 is a flowchart of an example method for density-aware fill with boundary compensation according to some embodiments of the present disclosure.

FIG. 6 is a flowchart of an example method for density-aware fill with boundary compensation according to some embodiments of the present disclosure.

### DETAILED DESCRIPTION

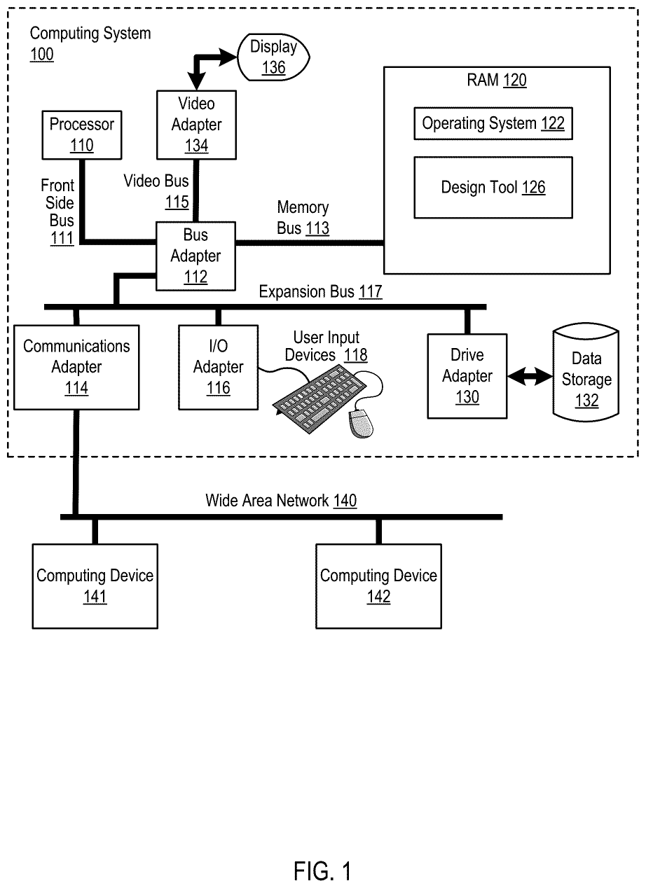

Exemplary apparatus and systems for density-aware fill with boundary compensation in accordance with the present disclosure are described with reference to the accompanying drawings, beginning with FIG. 1. FIG. 1 sets forth a block diagram of automated computing machinery comprising an exemplary computing system 100 configured for density-aware fill with boundary compensation according to embodiments of the present disclosure. The computing system 100 of FIG. 1 includes at least one computer processor 110 or ‘CPU’ as well as random access memory (‘RAM’) 120 which is connected through a high speed memory bus 113 and bus adapter 112 to processor 110 and to other components of the computing system 100.

Stored in RAM 120 is an operating system 122. Operating systems useful in computers configured for density-aware fill with boundary compensation according to embodiments of the present disclosure include z/OS™, UNIX™, Linux™, Microsoft Windows™. AIX™, and others as will occur to those of skill in the art. The operating system 122 in the example of FIG. 1 is shown in RAM 120, but many components of such software typically are stored in non-volatile memory also, such as, for example, on data storage 132, such as a disk drive.

Also stored in RAM is a design tool 126 configured for density-aware fill with boundary compensation according to embodiments of the present disclosure. The design tool 126 optimizes the amount of metal fill added to an integrated circuit (IC) design to target minimum density requirements and minimize detrimental effects caused by excess metal fill. In some examples, the design tool 126 is embodied in a set of computer program instructions that, when executed by the processor 110, cause the computing system 100 to carry out the steps of: identifying, based on one or more metal density constraints, a minimum density requirement for an integrated circuit (IC) design; determining a metal density for a tile of the IC design; identifying a target amount of metal fill based on metal density and the minimum density requirement; and integrating metal fill in the IC design based on the target amount of metal fill. In some examples, the minimum density requirement is compensated with a boundary guardband value, for example referring to potential differences in density measurements between a chip-level perspective and a perspective lower in the design hierarchy, which may or may not contain child regions of unknown density and/or parent regions of unknown density. A design shape may represent a functional metal interconnect a fill shape may represent non-functional metal.

In some implementations, the computer program instructions cause the computing system 100 to carry out the automated steps of: determining a design shape density based on design rule checking; determining a minimum number of fill shapes that will satisfy the minimum density requirement; and inserting the minimum number of fill shapes into the IC design.

In some implementations, the computer program instructions cause the computing system 100 to carry out the automated steps of: inserting metal fill in the IC design; determining a fill density based on a number of fill shapes that were inserted; estimating, based on the fill density, a design shape density; determining, based on the estimation of the design shape density, a number of fill shapes that can be removed while satisfying the minimum density requirement; and reducing metal fill that was inserted.

In some implementations, the computer program instructions cause the computing system 100 to carry out the automated steps of: estimating a design shape density based on a historical density; determining, based on the estimation of the design shape density, an estimated number of fill shapes will satisfy the minimum density requirement; and inserting the estimated number of fill shapes into the IC design.

In some implementations, the computer program instructions cause the computing system 100 to carry out the automated steps of: inserting metal fill in the IC design; determining a total metal density based on a design rule check; identifying an amount of metal fill in excess of the minimum density requirement; and removing metal fill in excess of the minimum density requirement.

The computing system 100 of FIG. 1 includes disk drive adapter 130 coupled through expansion bus 117 and bus adapter 112 to processor 110 and other components of the computing system 100. Disk drive adapter 130 connects non-volatile data storage to the computing system 100 in the form of data storage 132. Disk drive adapters useful in computers configured for inserting sequence numbers into editable tables according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 100 of FIG. 1 includes one or more input/output (‘I/O’) adapters 116. I/O adapters implement user-oriented input/output through, for example, software drivers and computer hardware for controlling output to display devices such as computer display screens, as well as user input from user input devices 118 such as keyboards and mice. The example computing system 100 of FIG. 1 includes a video adapter 134, which is an example of an I/O adapter specially designed for graphic output to a display device 136 such as a display screen or computer monitor. Video adapter 134 is connected to processor 110 through a high speed video bus 115, bus adapter 112, and the front side bus 111, which is also a high speed bus.

The exemplary computing system 100 of FIG. 1 includes a communications adapter 114 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for inserting sequence numbers into editable tables according to embodiments of the present disclosure include modems for wired dial-up communications, Ethernet (IEEE 802.3) adapters for wired data communications, and 802.11 adapters for wireless data communications. The communications adapter 114 of FIG. 1 is communicatively coupled to a wide area network 140 that also includes other computing devices, such as computing devices 141 and 142 as shown in FIG. 1.

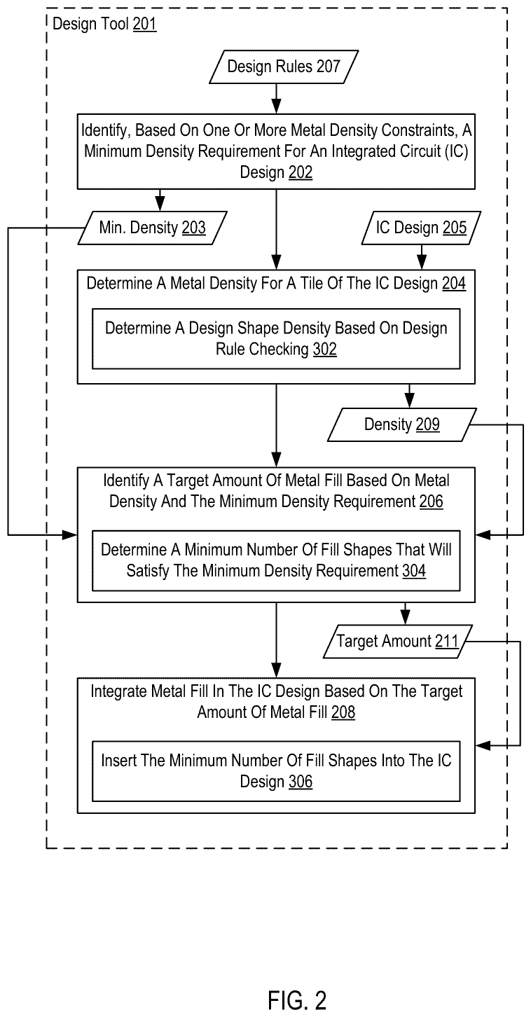

For further explanation, FIG. 2 sets forth a flowchart illustrating an example computing system density-aware fill with boundary compensation according to embodiments of the present disclosure. The method of FIG. 2 includes identifying 202, based on one or more metal density constraints, a minimum density requirement 203 for an integrated circuit design 205. In some examples, a design tool 201 identifies metal density constraints from a set of design rules 207 related to a semiconductor manufacturing process. The metal density constraints can include minimum and maximum metal density requirements for a tile of an IC design, where the design is subdivided into multiple tiles for design rule checking. Each tile may have a given area. Thus, a minimum density requirement may be minimum metal density for a given size tile. To aid illustration, the metal density constraints may include a requirement that the metal density is, for example, a minimum of 20% and a maximum 80% of the tile area.

Other metal density constraints may include gradient density rules limiting the deltas in metal densities between neighboring tiles. Thus, the minimum density requirement may be related to the density of a neighboring tile. Other metal density constraints may also include bump area rules that require a greater minimum metal density in areas of the die that are stacked over/under bump locations. Other metal density constraints may also include multilayer density rules that specify that a minimum density for an aggregate of two or more metal layers. Other metal density constraints may also limit variations between densities of standard cells or macros and chip-level densities. Thus, in some examples, the minimum density requirement is based on minimum densities for a tile size, minimum densities for cells or macros, chip-level density requirements, gradient density requirements, bump density requirements, and so on.

Design rule checking (DRC) is a design process to determine if die layout satisfies these density design rules, which may be specified by the semiconductor manufacturer based on their processes. In particular, DRC can identify the metal densities in the die and determine whether the metal density design rules are satisfied or violated. DRC is typically performed tile-by-tile for the entire chip. For density rules, DRC is typically performed on each metal layer, although some density requirements require a multilayer analysis.

In some examples, the design tool 201 identifies 202 the minimum density requirement 203 for application in the fill tooling phase of the design process, in which metal fill is inserted into the IC design. In some implementations, the design tool 201 modifies the minimum density requirement to add a boundary value that provides a buffer against errors in estimating the amount of fill to add to the IC design. For example, if the minimum density requirement specified by the design rule is 20%, the design tool 201 may utilize a minimum density requirement of 25%.

The method of FIG. 2 also includes determining 204 a metal density 209 for a tile of the integrated circuit design 205. The design tool 201 can determine 204 the metal density 209 in a variety of manners. In various examples, the design tool determines 204 the metal density 209 either before or after an initial metal fill insertion. The metal density 209 may reflect only the design shape density (the metal density of only the functional wires or interconnects) in the tile or the metal density 209 may reflect the total metal density of the tile including design shapes and fill shapes (non-functional metal fill from an initial fill insertion). In various examples, the design tool 201 determines 204 the metal density 209 based on DRC or based on estimation. For example, the design tool 201 can estimate the design shape metal density based on historical data or based on an amount of metal fill that was inserted on an initial fill. Various examples of determining 204 the metal density 209 will be explained in more detail below.

The method of FIG. 2 also includes identifying 206 a target amount 211 of metal fill based on metal density 209 and the minimum density requirement 203. In some examples, the design tool 201 identifies 206 the target amount 211 of metal fill based on a comparison of the designs shape density and the minimum density requirement. The target amount of metal fill is the amount of metal fill that should be included in the IC design to meet minimum metal density requirements while minimizing excess metal fill that is not necessary to satisfy the minimum density requirements. In some examples, the design tool identifies how much metal fill to add (when the analysis is performed prior to any fill insertion) based on the current design shape metal density and the minimum density requirement. In other examples, the design tool 201 identifies how much metal fill can be removed (when the analysis is performed after a fill insertion) while still satisfying the minimum density requirement, either based on an estimate of the design shape metal density or DRC.

The method of FIG. 2 also includes integrating 208 metal fill in the IC design based 205 on the target amount 211 of metal fill. In some examples, where the target amount 211 is determined prior to any fill insertion, the design tool 201 integrates 208 metal fill in the IC design based 205 on the target amount 211 by adding the target amount of metal fill. In other examples, where the target amount 211 is determined after an initial fill insertion, the design tool 201 integrates 208 metal fill in the IC design based 205 on the target amount 211 by removing metal fill such that the remaining metal fill is substantially equal to the target amount 211. As discussed above, the minimum density requirement may be compensated with a boundary value that provides a buffer against density errors. After adding or removing metal fill based on the target amount 211, fill tooling is complete and the IC design is advanced to the next phase of the design flow.

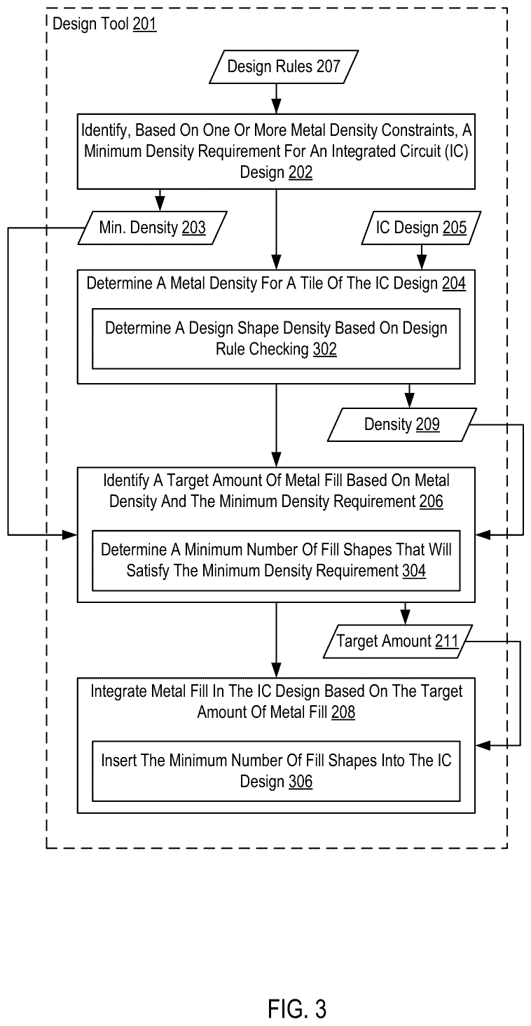

For further explanation, FIG. 3 sets forth a flowchart illustrating an example method of density-aware fill with boundary compensation according to embodiments of the present disclosure. The method of FIG. 3 extends the method of FIG. 2 in that the method of FIG. 3 includes determining 302 a design shape metal density based on design rule checking as part of determining 204 a metal density 209 for a tile of the IC design 205. In some examples, the design tool 201 determines 302 a design shape metal density based on a design rule check by determining the metal density of the of the design shapes, prior to any fill insertion, by performing DRC on the IC design 205. The result of the DRC is the metal density of the tile based only on the design shapes, or functional metal, in the design.

The method of FIG. 3 also includes determining 304 a minimum number of fill shapes will satisfy the minimum density requirement 203 as part of identifying 206 a target amount 211 of metal fill based on metal density 209 and the minimum density requirement 203. Having determined the design shape metal density, the design tool 201 can calculate the target amount of metal fill as the difference between the design shape metal density and the minimum density requirement. In some examples, metal fill is inserted as gridded shapes of a fixed size. In such examples, the design tool 201 counts the number of fill shapes that are needed to meet the target amount 211 of metal fill.

The method of FIG. 3 also includes inserting 306 the minimum number of fill shapes into the IC design as part of integrating 208 metal fill in the IC design based 205 on the target amount 211 of metal fill. The design tool inserts, as part of fill tooling, 306 the minimum number of fill shapes that have been determined to satisfy the target amount of metal fill. The process is repeated for each tile, after which the fill process for the IC design is deemed completed. Because DRC was performed prior to any fill insertion, fill insertion can be performed just once with assurance that that the amount of metal fill inserted does not substantially exceed the minimum amount of metal fill needed to meet the metal density requirement.

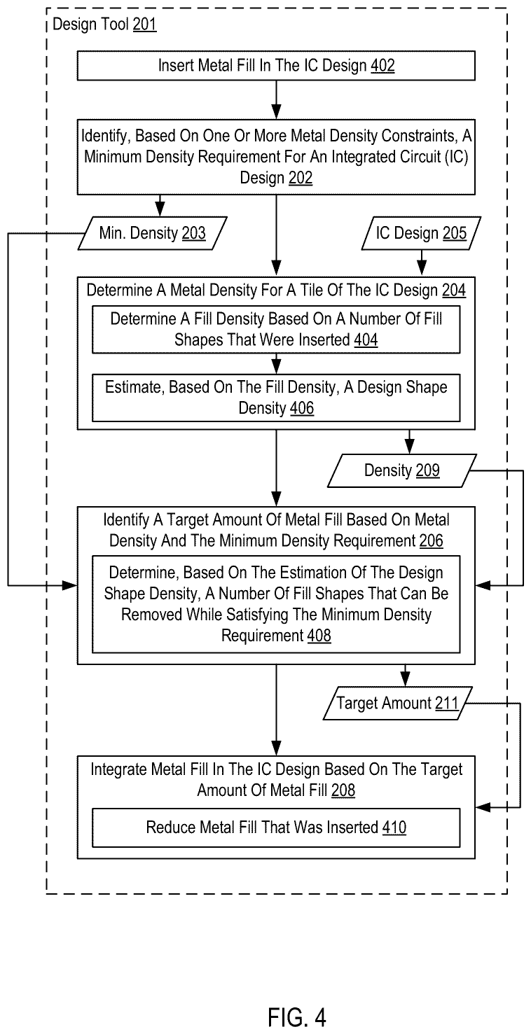

For further explanation, FIG. 4 sets forth a flowchart illustrating an example method of density-aware fill with boundary compensation according to embodiments of the present disclosure. The method of FIG. 4 extends the method of FIG. 2 in that the method of FIG. 4 first includes inserting 402 metal fill in the IC design. In some implementations, the design tool 201 first inserts 402 metal fill using a ‘greedy’ algorithm that places fill shapes without targeting a minimum amount of metal fill to add to the design. For example, such an algorithm might place fill shapes in any open space that they will fit. The amount of metal fill that is added can be used to estimate the design shape density, as explained below.

The method of FIG. 4 also includes determining 404 a fill metal density based on a number of fill shapes that were inserted as part of determining 204 a metal density 209 for a tile of the integrated circuit design 205. In some implementations, the design tool 201 determines the fill metal density without design rule checking the tile after metal fill insertion. Rather, the design metal tool 201 determines 404 the fill metal density by counting the number of fill shapes that were added to the IC design 205. For example, the number of fill shapes that were added can be identified from fill tooling logs. The density of the fill metal added during fill insertion is calculated, for a given tile size, based on the number of fill shapes added and the fixed size of those fill shapes.

The method of FIG. 4 also includes estimating 406, based on the fill density, a design shape density as part of determining 204 a metal density 209 for a tile of the integrated circuit design 205. In some implementations, the design tool 201 estimates 406 the design shape density by extrapolating the design shape density from the density of the fill metal that the greedy algorithm was able to add. That is, the greedy algorithm will add fill shapes to any open space of a track in which a fill metal shape will fit. For any remaining track spaces where a fill shape was not added, that space is either occupied by a design shape or too small to fit a fill shape. A ceiling on the design shape density can be predicted if it is assumed that there were no spaces too small for a fill shape to fit. That is, in such a scenario, fill shapes occupy every track space in of the tile that is not occupied by a design shape and there are no open spaces after fill insertion. For example, if the fill density is 85% then the design shape density is at most 15%. If the minimum density requirement is 25%, then potentially 75% of the metal fill is excess metal fill. However, it is typical that there will be some spaces between design shapes in which fill shapes will not fit. Thus, the design shape density might be lower than predicted. Statistical or historical analysis can be used to estimate the occurrence of such cases and thus adjust the value of the predicted design shape density.

The method of FIG. 4 also includes determining 408, based on the estimation of the design shape density, a number of fill shapes that can be removed while satisfying the minimum density requirement as part of identifying 206 a target amount 211 of metal fill based on metal density 209 and the minimum density requirement 203. In some examples, the design tool 201 uses the estimated design shape density to identify the amount of metal fill needed to satisfy the minimum density requirement. That is, the design tool 201 can calculate the target amount 211 of metal fill as the difference between the design shape metal density and the minimum density for the tile. The design tool 201 can then calculate the amount of excess fill as the difference between the target amount 211 and the fill density based on the count of fill shapes inserted. Thus, in some implementations, the design tool 201 determines 408 the number of fill shapes that can be removed based on the amount of excess metal fill that was inserted as gridded shapes of a fixed size.

The method of FIG. 4 also includes reducing 410 metal fill that was inserted as part of integrating 208 metal fill in the IC design based 205 on the target amount 211 of metal fill. In some implementations, the design tool 201 reduces 410 metal fill by depopulating the fill shapes that were inserted by the number of fill shapes can be removed while satisfying the minimum density requirement. After the fill shapes have been removed, the fill tooling process is deemed complete. Thus, fill tooling is completed without DRC and with only one fill insertion phase by estimating the design shape density based on the initial fill insertion, which provides assurance that that the amount of metal fill finally included does not substantially exceed the minimum amount of metal fill needed to meet the metal density requirement.

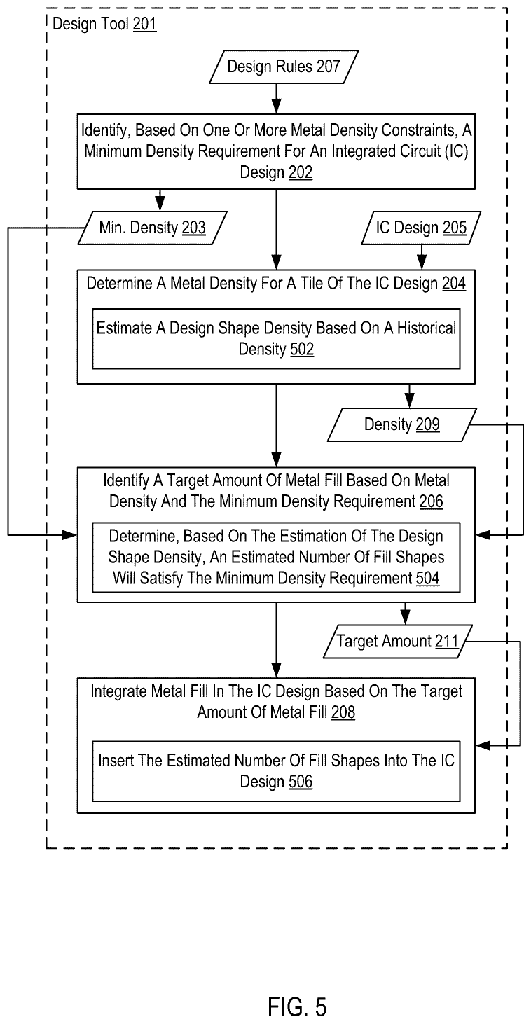

For further explanation, FIG. 5 sets forth a flowchart illustrating an example method of density-aware fill with boundary compensation according to embodiments of the present disclosure. The method of FIG. 5 extends the method of FIG. 2 in that the method of FIG. 5 includes estimating 502 a design shape density based on a historical density as part of determining 204 a metal density 209 for a tile of the integrated circuit design 205. The various phases of the IC design flow must be repeated as IC designs are updated. For example, fill tooling must be repeated if the IC design is updated, and subsequently the IC design will undergo design rule checking to ensure that the updated IC design is in compliance with design rules (e.g., that there are no density violations). As previous iterations of the design have already undergone design rule checking, the design tool 201 can leverage the density determinations from that design rule checking. Thus, in some implementations, the design tool 201 estimates 502 a design shape density based on a historical density by accessing a record of the previously determined densities. These densities can include the design shape density, the fill density, the total density, or a combination thereof for each tile of the IC design. This estimation is based on an assumption, or statistical or historical estimation, that the design shape density will not substantially change between IC design iterations.

The method of FIG. 5 also includes determining 504, based on the estimation of the design shape density, an estimated number of fill shapes will satisfy the minimum density requirement as part of identifying 206 a target amount 211 of metal fill based on metal density 209 and the minimum density requirement 203. Having estimated the design shape metal density based on historical data, the design tool 201 can calculate the target amount 211 of metal fill as the difference between the estimated design shape metal density and the minimum density requirement. In some examples, metal fill is inserted as gridded shapes of a fixed size. In such examples, the design tool 201 counts the number of fill shapes that are needed to meet the target amount 211 of metal fill.

The method of FIG. 5 also includes inserting 506 the estimated number of fill shapes into the IC design as part of integrating 208 metal fill in the IC design based 205 on the target amount 211 of metal fill. The design tool inserts, as part of fill tooling, 506 the number of fill shapes that have been estimated to satisfy the target amount of metal fill. At this point, the fill process for the tile is deemed completed. Because density estimations were determined from historical data, no new design rule checking is needed to complete the fill tooling. Because fill tooling in this implementation does not require new design rule checking to achieve the reduction in fill metal, the runtime performance of the design tool 201 is improved. Fill insertion can be performed just once with assurance that that the amount of metal fill inserted does not substantially exceed the minimum amount of metal fill needed to meet the metal density requirement.

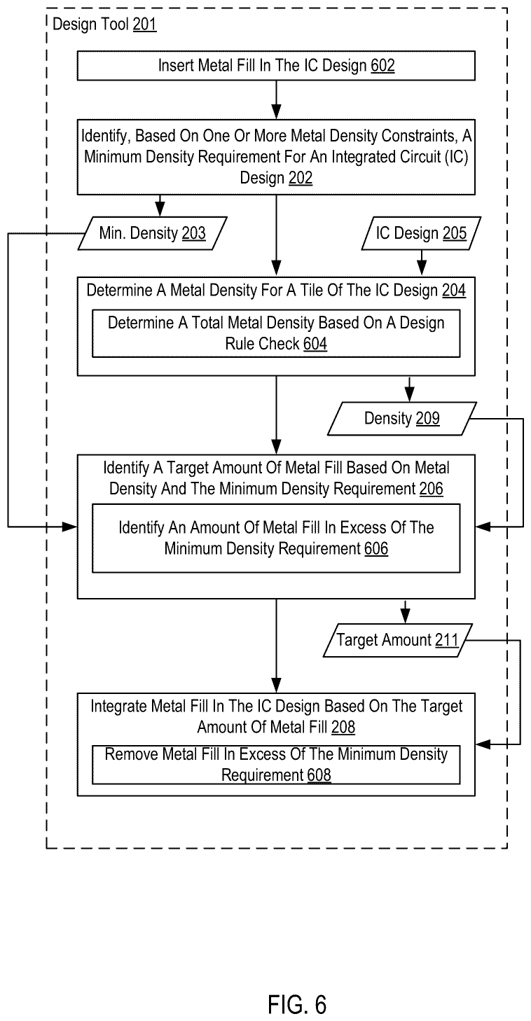

For further explanation, FIG. 6 sets forth a flowchart illustrating an example method of density-aware fill with boundary compensation according to embodiments of the present disclosure. The method of FIG. 6 extends the method of FIG. 2 in that the method of FIG. 6 furth includes inserting 602 metal fill in the IC design. In some implementations, the design tool 201 first inserts 602 metal fill using a ‘greedy’ algorithm that places fill shapes without targeting a minimum amount of metal fill to add to the design. For example, such an algorithm might place fill shapes in any open space that they will fit. The amount of metal fill that is added can be reduced after design rule checking, as explained below.

The method of FIG. 6 also includes determining 604 a total metal density based on a design rule check as part of determining 204 a metal density 209 for a tile of the integrated circuit design 205. In some implementations, the design tool 201 applies design rule checking during fill tooling to determine 604 determine the total metal density of the IC design after an initial metal fill insertion.

The method of FIG. 6 also includes identifying 606 an amount of metal fill in excess of the minimum density requirement as part of identifying 206 a target amount 211 of metal fill based on metal density 209 and the minimum density requirement 203. In some implementations, the design tool identifies 606 the amount of excess fill as the difference between the total metal density and the minimum density requirement 203. The design tool determines, based on this difference, the number of excess fill shapes that can be removed from the IC design.

The method of FIG. 6 also includes removing 608 metal fill in excess of the minimum density requirement as part of integrating 208 metal fill in the IC design based 205 on the target amount 211 of metal fill. In some implementations, the design tool 201 removes 608 metal fill in excess of the minimum requirement by depopulating the fill shapes that were initially inserted based on the number of excess fill shapes. After the fill shapes have been removed, the fill tooling process is deemed complete. Thus, fill tooling is completed with one design rule checking phase and two fill insertion phases to provide assurance that that the amount of metal fill finally included does not substantially exceed the minimum amount of metal fill needed to meet the metal density requirement.

In view of the explanations set forth above, readers will recognize a number of advantages of density-aware fill with boundary compensation according to embodiments of the present disclosure including:
Optimizing the amount of fill throughout a design to reduces unnecessary metal fill while meeting a worst-case set of minimum density rules.
Reducing unnecessary fill improves the power, performance, and area of paths containing wires that would otherwise have increased capacitance because of that fill (e.g., power and performance will improve with reduced capacitance, while power and area will improve because of the reduced drive strength needed to hit a given performance target).
Optimizing fill tooling to achieve this reduction increases runtime performance of fill tooling.

Exemplary embodiments of the present disclosure are described largely in the context of a fully functional computer system for density-aware fill with boundary compensation. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order. depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of density-aware fill with boundary compensation, the method comprising:
identifying, based on one or more metal density constraints, a minimum density requirement for an integrated circuit (IC) design;
determining a metal density for a tile of the IC design;
identifying a target amount of metal fill based on metal density and the minimum density requirement; and
integrating metal fill in the IC design based on the target amount of metal fill.

2. The method of claim 1, wherein determining a metal density for a tile of the IC design includes:
determining a design shape density based on design rule checking;
wherein identifying a target amount of metal fill based on the metal density and the minimum density requirement includes:
determining a minimum number of fill shapes that will satisfy the minimum density requirement; and
wherein integrating metal fill in the IC design based on the target amount of metal fill includes:
inserting the minimum number of fill shapes into the IC design.

3. The method of claim 1 further comprising:
inserting metal fill in the IC design,
wherein determining a metal density for a tile of the IC design includes:
determining a fill density based on a number of fill shapes that were inserted; and
estimating, based on the fill density, a design shape density;
wherein identifying a target amount of metal fill based on the metal density and the minimum density requirement includes:
determining, based on the estimation of the design shape density, a number of fill shapes that can be removed while satisfying the minimum density requirement; and
wherein integrating metal fill in the IC design based on the target amount of metal fill includes:
reducing metal fill that was inserted.

4. The method of claim 1, wherein determining a metal density for a tile of the IC design includes:
estimating a design shape density based on a historical density;
wherein identifying a target amount of metal fill based on the metal density and the minimum density requirement includes:
determining, based on the estimation of the design shape density, an estimated number of fill shapes will satisfy the minimum density requirement; and
wherein integrating metal fill in the IC design based on the target amount of metal fill includes:
inserting the estimated number of fill shapes into the IC design.

5. The method of claim 1 further comprising:
inserting metal fill in the IC design,
wherein determining a metal density for a tile of the IC design includes:
determining a total metal density based on a design rule check;
wherein identifying a target amount of metal fill based on the metal density and the minimum density requirement includes:
identifying an amount of metal fill in excess of the minimum density requirement; and
wherein integrating metal fill in the IC design based on the target amount of metal fill includes:
removing metal fill in excess of the minimum density requirement.

6. The method of claim 1, wherein the minimum density requirement is compensated with a boundary guardband value.

7. The method of claim 1, wherein a design shape represents a functional metal interconnect, and wherein a fill shape represents non-functional metal.

8. An apparatus for density-aware fill with boundary compensation, the apparatus comprising a computer processor, a computer memory operatively coupled to the computer processor, the computer memory having disposed therein computer program instructions that, when executed by the computer processor, cause the apparatus to carry out the steps of:
identifying, based on one or more metal density constraints, a minimum density requirement for an integrated circuit (IC) design;
determining a metal density for a tile of the IC design;
identifying a target amount of metal fill based on metal density and the minimum density requirement; and
integrating metal fill in the IC design based on the target amount of metal fill.

9. The apparatus of claim 8, wherein determining a metal density for a tile of the IC design includes:
determining a design shape density based on design rule checking;
wherein identifying a target amount of metal fill based on the metal density and the minimum density requirement includes:
determining a minimum number of fill shapes that will satisfy the minimum density requirement; and
wherein integrating metal fill in the IC design based on the target amount of metal fill includes:
inserting the minimum number of fill shapes into the IC design.

10. The apparatus of claim 8 further comprising computer program instructions that, when executed by the processor, cause the apparatus to carry out the step of:
inserting metal fill in the IC design,
wherein determining a metal density for a tile of the IC design includes:
determining a fill density based on a number of fill shapes that were inserted; and
estimating, based on the fill density, a design shape density;
wherein identifying a target amount of metal fill based on the metal density and the minimum density requirement includes:
determining, based on the estimation of the design shape density, a number of fill shapes that can be removed while satisfying the minimum density requirement; and
wherein integrating metal fill in the IC design based on the target amount of metal fill includes:
reducing metal fill that was inserted.

11. The apparatus of claim 8, wherein determining a metal density for a tile of the IC design includes:
estimating a design shape density based on a historical density;
wherein identifying a target amount of metal fill based on the metal density and the minimum density requirement includes:
determining, based on the estimation of the design shape density, an estimated number of fill shapes will satisfy the minimum density requirement; and
wherein integrating metal fill in the IC design based on the target amount of metal fill includes:
inserting the estimated number of fill shapes into the IC design.

12. The apparatus of claim 8 further comprising computer program instructions that, when executed by the processor, cause the apparatus to carry out the step of:
inserting metal fill in the IC design,
wherein determining a metal density for a tile of the IC design includes:
determining a total metal density based on a design rule check;
wherein identifying a target amount of metal fill based on the metal density and the minimum density requirement includes:
identifying an amount of metal fill in excess of the minimum density requirement; and
wherein integrating metal fill in the IC design based on the target amount of metal fill includes:
removing metal fill in excess of the minimum density requirement.

13. The apparatus of claim 8, wherein the minimum density requirement is compensated with a boundary guardband value.

14. The apparatus of claim 8, wherein a design shape represents a functional metal interconnect, and wherein a fill shape represents non-functional metal.

15. A computer program product for density-aware fill with boundary compensation, the computer program product disposed upon a computer readable medium, the computer program product comprising computer program instructions that, when executed, cause a computer to carry out the steps of:
identifying, based on one or more metal density constraints, a minimum density requirement for an integrated circuit (IC) design;
determining a metal density for a tile of the IC design;
identifying a target amount of metal fill based on metal density and the minimum density requirement; and
integrating metal fill in the IC design based on the target amount of metal fill.

16. The computer program product of claim 15, wherein determining a metal density for a tile of the IC design includes:
determining a design shape density based on design rule checking,
wherein identifying a target amount of metal fill based on the metal density and the minimum density requirement includes:
determining a minimum number of fill shapes that will satisfy the minimum density requirement; and
wherein integrating metal fill in the IC design based on the target amount of metal fill includes:
inserting the minimum number of fill shapes into the IC design.

17. The computer program product of claim 15 further comprising computer program instructions that, when executed, cause the computer to carry out the step of:
inserting metal fill in the IC design,
wherein determining a metal density for a tile of the IC design includes:
determining a fill density based on a number of fill shapes that were inserted; and
estimating, based on the fill density, a design shape density;
wherein identifying a target amount of metal fill based on the metal density and the minimum density requirement includes:
determining, based on the estimation of the design shape density, a number of fill shapes that can be removed while satisfying the minimum density requirement; and
wherein integrating metal fill in the IC design based on the target amount of metal fill includes:
reducing metal fill that was inserted.

18. The computer program product of claim 15, wherein determining a metal density for a tile of the IC design includes:
estimating a design shape density based on a historical density,
wherein identifying a target amount of metal fill based on the metal density and the minimum density requirement includes:
determining, based on the estimation of the design shape density, an estimated number of fill shapes will satisfy the minimum density requirement; and
wherein integrating metal fill in the IC design based on the target amount of metal fill includes:
inserting the estimated number of fill shapes into the IC design.

19. The computer program product of claim 15 further comprising computer program instructions that, when executed, cause the computer to carry out the step of:
inserting metal fill in the IC design,
wherein determining a metal density for a tile of the IC design includes:
determining a total metal density based on a design rule check;
wherein identifying a target amount of metal fill based on the metal density and the minimum density requirement includes:
identifying an amount of metal fill in excess of the minimum density requirement; and
wherein integrating metal fill in the IC design based on the target amount of metal fill includes:
removing metal fill in excess of the minimum density requirement.

20. The computer program product of claim 15, wherein the minimum density requirement is compensated with a boundary guardband value.
